(19) United States
(12) Patent Application Publication
(10) Pub. No.: US 2004/0088380 A1
(43) Pub. Date: May 6, 2004

(54) Splitting and redundant storage on multiple servers

(76) Inventors: Randall M. Chung, Laguna Niguel, CA (US); Maged Bishay, Costa Mesa, CA (US); Michael Zelevinsky, San Diego, CA (US); Sivagnanam Parthasarathy, Carlsbad, CA (US)

Correspondence Address: Irell & Manella, Suite 400, 840 Newport Center Drive, Newport Beach, CA, 92660, US

(21) Appl. No.: 10/471,849

(22) PCT Filed: Mar. 12, 2002
(86) PCT No.: PCT/US02/07724

(51) Int. Cl. G06F 15/16

(52) U.S. Cl. 709/219

(57) ABSTRACT

One aspect of the invention involves dividing a single file (300) into multiple sub-files (310, 320, 330, 340) that are subsequently distributed and stored onto one or more servers. The sub-files (310, 320, 330, 340) may be transmitted in parallel and simultaneously from one or more servers, which increases the rate at which the data can be delivered. A second aspect of the invention involves storing at least one of the sub-files (310, 320, 330, 340) on more than one server to provide redundancy. If one server is not available, or if the transmission link is slow or not available, the sub-file can be streamed from another server. In one embodiment, each end user may receive multiple sub-files simultaneously from multiple servers. Disk input/output bandwidth is saved because only the necessary fraction of data needs to be read from each server.

The present invention claims priority to U.S. provisional patent application Ser. No. 60/275,408, entitled “Splitting and Redundant Storage on Multiple Servers”, filed Mar. 12, 2001 and U.S. provisional patent application Ser. No. 60/275,407, entitled “Re-Assembly of Streaming Files from Separate Connections,” filed Mar. 12, 2001. The present application is also related to pending PCT Application No. PCT/US ______, entitled “Re-Assembly of Streaming Files from Separate Connections,” filed Mar. 12, 2002, which is assigned to the assignee of the present application, the subject matter of which is incorporated herein by reference.

### BACKGROUND OF THE INVENTION

1. Field of the Invention

The present invention relates generally to data communication networks and more particularly to a method and apparatus for splitting a file for storage and distribution over a plurality of servers. In one embodiment, a sub file may reside on more than one server, thus providing redundancy.

2. Related Art

Replicating an entire file onto multiple file servers is a technique that can be used to speed up the delivery of data. Once the data has been replicated onto multiple servers, and the servers have been geographically dispersed, the data can be delivered to an end user from the closest available server. Also, the data can be delivered from multiple servers simultaneously, where each server provides a portion of the total file. However, replicating the full file onto a large number of servers uses large amounts of expensive disk storage. For instance, a system consisting of a hundred servers with 100 gigabytes of storage each would have a total of 10,000 gigabytes of storage available if data were not replicated. If all files must be fully replicated onto each server, however, the system would only be able to store 100 gigabytes of unique files.

Another problem of full file replication is that disk input/output bandwidth can be wasted if a file is read in its entirety, but only a portion of the file is used or needed.

Accordingly, there is a need in the technology to overcome the aforementioned problems.

### BRIEF SUMMARY OF THE INVENTION

One aspect of the invention involves dividing a single file into multiple sub-files that are subsequently distributed and stored onto one or more servers. The sub-files may be transmitted in parallel and simultaneously from one or more servers, which increases the rate at which data can be delivered.

A second aspect of the invention involves storing at least one of the sub-files on more than one server to provide redundancy. If one server is not available, or if the transmission link is slow or not available, the sub-file can be streamed from another server. In one embodiment, each end user may receive multiple sub-files simultaneously from multiple servers. Disk input/output bandwidth is saved because only the necessary fraction of the data needs to be read from each server.

### BRIEF DESCRIPTION OF THE DRAWINGS

FIG. 1 is a system block diagram of one embodiment of a network system in which the system and method of the invention may be implemented.

FIG. 2 is a system block diagram of one embodiment of a computer system which implements the embodiments of the invention.

FIG. 3 illustrates one embodiment of a process for splitting and distributing a file, in accordance with the principles of the invention.

FIG. 4 illustrates one embodiment of a process for replicating storage of sub files, provided in accordance with the principles of the invention.

FIG. 5 is a system block diagram of one embodiment of a system that implements the process of the invention.

FIG. 6 is a flow diagram that illustrates one embodiment of the process of the invention.

### DETAILED DESCRIPTION OF THE EMBODIMENTS

One aspect of the invention involves dividing a single file into multiple files or sub-files. A sub-file has a file name and other file attributes, and is treated by the operating system's file system as just another file. The divided files or sub-files may then be distributed and stored onto one or more servers. When an end user wants the file to be delivered in a streaming fashion, the sub-files can be transmitted in parallel and simultaneously from one or more servers, which increases the rate at which data can be delivered.

A second aspect of the invention provides that each sub-file may reside on more than one server to provide redundancy. If one server is not available, or if the transmission link is slow or not available, the sub-file can be streamed from another server. In one embodiment, each end user may receive multiple sub-files simultaneously from multiple servers. Disk input/output bandwidth is saved because only the necessary fraction of the data needs to be read from each server. In an ordinary system, the full file would have to be read on each server, even though only a portion of the data is needed.

### Definitions

As discussed herein, a “computer system” is a product including circuitry capable of processing data. The computer system may include, but is not limited to, general purpose computer systems (e.g., server, laptop, desktop, palmtop, personal electronic devices, etc.), personal computers (PCs), hard copy equipment (e.g., printer, plotter, fax machine, etc.), banking equipment (e.g., an automated teller machine), and the like. Content and/or media elements refers to application programs, driver programs, utility programs, file, payload, and combinations thereof, as well as graphics, informational material (articles, stock quotes, etc.) and the like, either singly or in any combination. A “communication link” refers to the medium or channel of communication. The communication link may include, but is not limited to, a telephone line, a modem connection, an Internet connection, an Integrated Services Digital Network (“ISDN”) connection, an Asynchronous Transfer Mode (ATM) connection, a frame relay connection, an Ethernet connection, a coaxial connection, a fiber optic connection, satellite connections (e.g. Digital Satellite Services, etc.), wireless connections, radio frequency (RF) links, electromagnetic links, two way paging connections, etc., and combinations thereof.

### System Overview

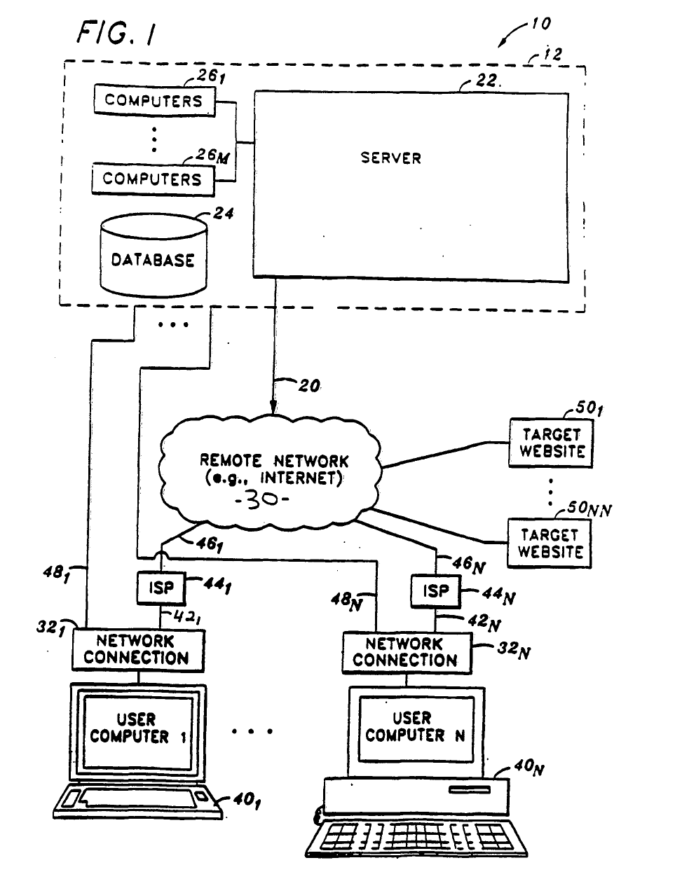

A description of an exemplary system, which incorporates embodiments of the invention, is herein described. FIG. 1 shows a system block diagram of one embodiment of a network system 10 in which the apparatus and method of the invention is used. Referring to FIG. 1, the network system 10 comprises a service center 12 that is connected over one or more communication links 20 to a remote network 30 (e.g., a wide area network or the Internet) or a remote site (e.g., a satellite, which is not shown in FIG. 1) to one or more user computer systems 40₁-40_{N} (“40”). In one embodiment the service center 12 is a website. The service center 12 includes one or more servers 22 and one or more databases 24. In one embodiment, the server 22 includes software modules that may be downloaded for performing the processes of the invention, as described in detail in the following sections. In addition, there may be more than one service center 12, each having one or more servers.

The service center 12 may also include one or more computers 26₁-26_{M}. If a plurality of computers are used, then the computers 26₁-26_{M} may be connected by a local area network (LAN) or any other similar connection technology. However, it is also possible for the service center 12 to have other configurations. For example, a smaller number of larger computers (i.e. a few mainframe, mini, etc. computers) with a number of internal programs or processes running on the larger computers capable of establishing communication links to the user computers.

The remote network 30 or remote site allows the service center 12 to provide peer-to-peer or client/server information and services to the user computers 40₁₋₄₀_{N}, using software that is stored at the service center 12. In one embodiment, the user computers 40 may be any computer system or any other device that processes and/or presents audio and/or video information. The one or more databases 24 connected to the service center computer(s), e.g., computer 261, are used to store data. Each user computer 40 is connected via network connection 32₁-32_{N} over a corresponding communication link 42₁-42_{N} such as a local carrier exchange to a respective ISP 44₁-44_{N}, through which access to the remote network 30 is made.

By inputting the URL address of the target website with which the user desires to interact, the user may be connected to various target websites, such as websites 50₁-50_{NN}. In an alternate embodiment, each user computer 40 may be connected via network connection 32₁-32_{N} over a corresponding communication link 48₁-48_{N} to the service center 12, which provides internet access and service to the user computer(s) 40. In a further embodiment, the display screen for viewing the content or media elements may be located on a television coupled to the network 30. In this case, navigation through the content or media elements may be provided through the use of control buttons on a remote control unit for controlling viewing of the television, or by other means known in the art.

One aspect of the present invention relates to retrieval and delivery of content and/or media elements. The software for providing such processes may be developed and/or stored on a computer 40, or may be developed using one of the computers 26₁-26_{M}. Upon completion of the development process, the software may be stored in the computer 40 or in the database 24. Alternatively, the software may be stored on a machine-readable medium, in any of the computers 40 or computers 26₁-26_{M}.

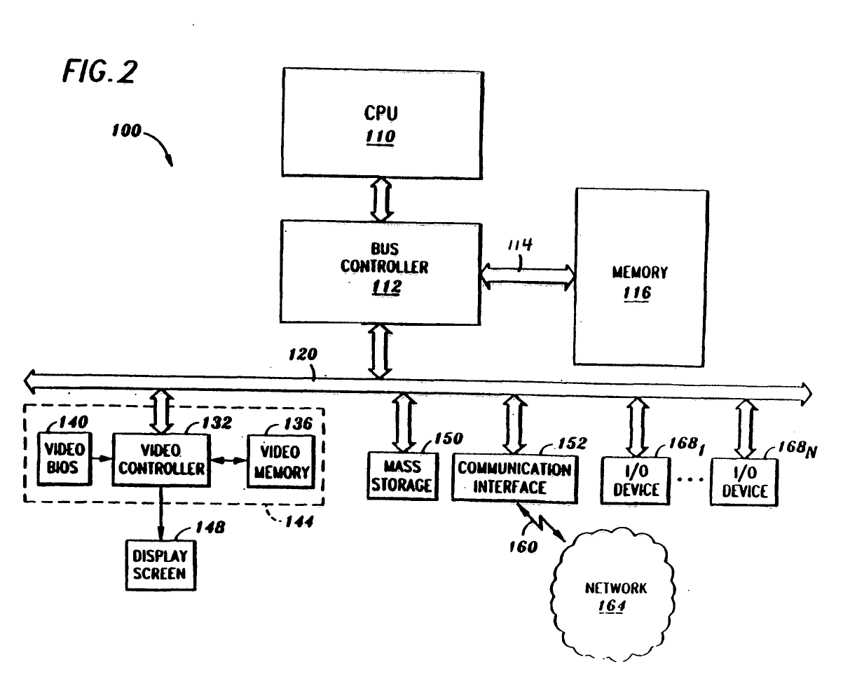

Referring to FIG. 2, the computer system 100 (representing either of computer 26 or 40) comprises a processor or a central processing unit (CPU) 110. The illustrated CPU 110 includes an Arithmetic Logic Unit (ALU) for performing computations, a collection of registers for temporary storage of data and instructions, and a control unit for controlling operation for the system 100. In one embodiment, the CPU 110 includes any one of the x86, Pentium™, Pentium II™, and Pentium Pro™ microprocessors as marketed by Intel™ Corporation, the K-6 microprocessor as marketed by AMD™, or the 6x86MX microprocessor as marketed by Cyrix™ Corp. Further examples include the Alpha™ processor as marketed by Digital Equipment Corporation™, the 680X0 processor as marketed by Motorola™; or the Power PC™ processor as marketed by IBM™. In addition, any of a variety of other processors, including those from Sun Microsystems, MIPS, IBM, Motorola, NEC, Cyrix, AMD, Nexgen and others may be used for implementing CPU 110. The CPU 110 is not limited to microprocessor but may take on other forms such as microcontrollers, digital signal processors, reduced instruction set computers (RISC), application specific integrated circuits, and the like. Although shown with one CPU 110, computer system 100 may alternatively include multiple processing units.

The CPU 110 is coupled to a bus controller 112. The bus controller 112 may include a memory controller (not shown) integrated therein, though the memory controller may be external to the bus controller 112. The memory controller provides an interface for access by the CPU 110 or other devices to memory 116 via memory bus 114. In one embodiment, the system memory 116 includes synchronous dynamic random access memory (SDRAM). System memory 116 may optionally include any additional or alternative high speed memory device or memory circuitry. The bus controller 112 is coupled to a system bus 120 that may be a peripheral component interconnect (PCI) bus, Industry Standard Architecture (ISA) bus, etc. Coupled to the system bus 120 are a graphics controller, a graphics engine or a video controller 132, a mass storage device 150, a communication interface device 152, and one or more input/output (I/O) devices 168₁-168_{N}. The video controller 132 is coupled to a video memory 136 (e.g., 8 Megabytes) and video BIOS 140, all of which may be integrated onto a single card or device, as designated by numeral 144. The video memory 136 is used to contain display data for displaying information on the display screen 148, and the video BIOS 140 includes code and video services for controlling the video controller 132. In another embodiment, the video controller 132 is coupled to the CPU 110 through an Advanced Graphics Port (AGP) bus.

The mass storage device 150 includes (but is not limited to) a hard disc, floppy disc, CD-ROM, DVD-ROM, tape, high density floppy, high capacity removable media, low capacity removable media, solid state memory device, etc., and combinations thereof The mass storage device 150 may include any other mass storage medium. The communication interface device 152 includes a network card, a modem interface, etc. for accessing network 164 via communications link 160. The I/O devices 168₁-168_{N} include a keyboard, mouse, audio/sound card, printer, and the like. The J/O devices 168₁-168_{N} may be disk drive, such as a compact disc (CD) drive, a hard disc drive, a tape drive, a zip drive, a jazz drive, a digital versatile disc (DVD) drive, a magneto-optical disk drive, a high density floppy drive, a high capacity removable media drive, a low capacity media device, and/or any combination thereof

The information, content and/or application software may be stored in the database 24, on the computers 40, or on a machine-readable medium. The information, content and/or application software may also be made available to users such as those located at user computer 1-N, i.e., computers 40₁-40_{N}, through service center 12 or by means of the machine-readable medium.

As discussed earlier, one aspect of the invention relates to a system and method for providing media over a network in a non-sequential fashion. In one embodiment, a request may be made by a user for content or media elements. The system and process of the invention may retrieve the desired content/media element from either database 24 or one of target websites 50₁-50_{NN}. The retrieved content/media element is then processed (e.g., decompressed, formatted, etc.). Users may then view the processed content/media element on a display device, such as a user computer 40. In another embodiment, the desired content/media is provided to the user in a non-sequential fashion.

In accordance with the practices of persons skilled in the art of computer programming, the invention is described below with reference to symbolic representations of operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data its at memory locations such as in system memory, as well as other processing of signals. The memory locations where data its are maintained are physical locations that have particular electrical, magnetic, optical, or organic properties corresponding to the data bits. Thus, the term “server” is understood to include any electronic device that contains a processor, such as a central processing unit.

When implemented in software, the elements of the invention are essentially the code segments to perform the necessary tasks. The program or code segments can be stored in a processor readable medium or transmitted by a computer data signal embodied in a carrier wave over a transmission medium or communication link. The “processor readable medium” or “machine-readable medium” may include any medium that can store or transfer information. Examples of the processor readable medium include an electronic circuit, a semiconductor memory device, a read only memory (ROM), a flash memory, an erasable ROM (EROM), a floppy diskette, a compact disk ROM (CD-ROM), an optical disk, a hard disk, a fiber optic medium, etc. The computer data signal may include any signal that can propagate over a transmission medium such as electronic network channels, optical fibers, air, electromagnetic links, a radio-frequency link, etc. The codes segments may be downloaded via computer networks such as the Internet, Intranet, etc.

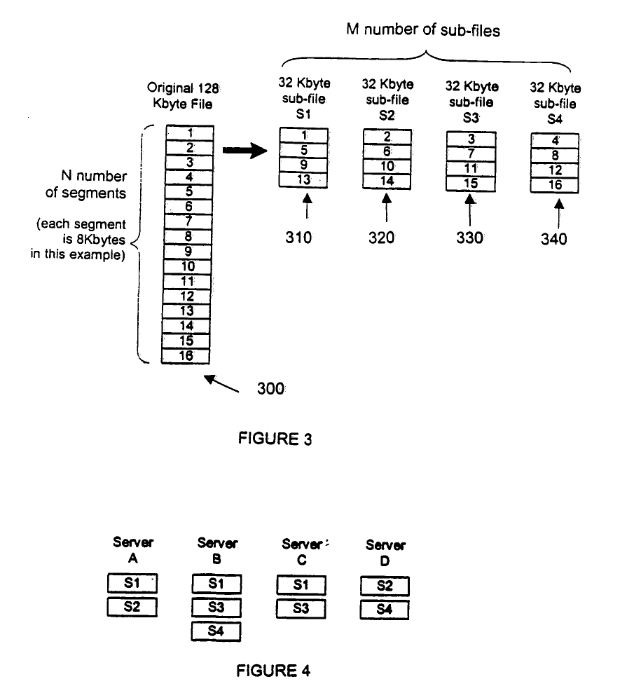

FIG. 3 illustrates one embodiment of a process for dividing a file, in accordance with the principles of the invention. In this embodiment, a 128 kilobyte file is divided and distributed. The size of the file is merely illustrative, and it is understood that the invention may be implemented using a file of a greater or smaller size. Such a file may include text, data, graphics, video clips, JPEG elements or images, static photographs, web pages, audio clips, animation, any type of informational material or any combination thereof.

Prior to transmission, the original file is configured for transmission. For example, the original file may be divided into N segments or chunks, where N is a positive integer. The N segments are assembled into M sub-files, where M is a positive integer. In the present example, the original 128 kilobyte file is split up into sixteen 8 KB segments (i.e., N=16 in the example). The sixteen segments are assembled into four sub-files (i.e., M=4 in the example), where the first 8 KB chunk of the original file goes into the first sub-file S1, the second chunk of the original file goes into the second sub-file S2, and so on. The fifth chunk of the original file would go into the first sub-file S1, after the first chunk of the original file. Thus, in one embodiment, the segments may be assigned to sub-files on a modulo 4 arrangement. Although in the present embodiment, the file is divided into 8 kilobyte segments, it is understood that the size of the segments and the number of sub-files is arbitrary. The invention may be implemented using a larger or smaller size chunk and a larger or smaller number of sub-files. In addition, each of the sub-files may be of different sizes. However, in one embodiment, the segments may be distributed in modulo order and the sub-files may be of substantially equal size.

The four sub-files S1 through S4 may be distributed to multiple servers. As shown in the example of FIG. 4, the first sub-file S1 may be distributed to three servers, servers A, B, and C. The second sub-file S2 may be distributed to servers D and A. The third sub-file S3 may be distributed to servers B and C. The fourth sub-file S4 may be distributed to servers D and B. It is understood that the sub-files may be distributed to a fewer or greater number of servers. Each sub file may be transmitted over a separate communication link, such as a TCP/IP connection to a receiver. In one embodiment, the Hyper Text Transfer Protocol (HTTP) may be used for each connection.

In one embodiment, the sub-files can be replicated so that the most frequently accessed files and sub-files are replicated onto more servers, while the less frequently accessed files and sub-files are replicated onto fewer servers. Thus, the sub files may be replicated onto multiple servers based on anticipated or actual demand. This saves disk space, since infrequently accessed files would take up less total disk space. Disk input/output bandwidth on each server would also be saved. For example, each server would read a 32 kilobyte sub-file and transmit the sub-file to the end user. If the files were not split up beforehand, each server would read the entire 128 kilobyte file, while transmitting only 32 kilobytes.

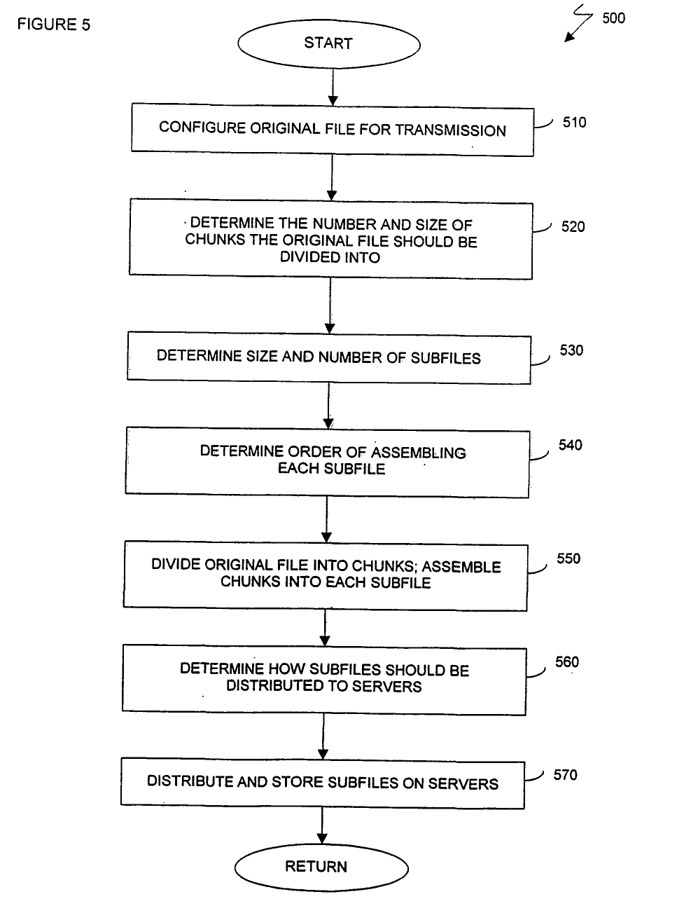

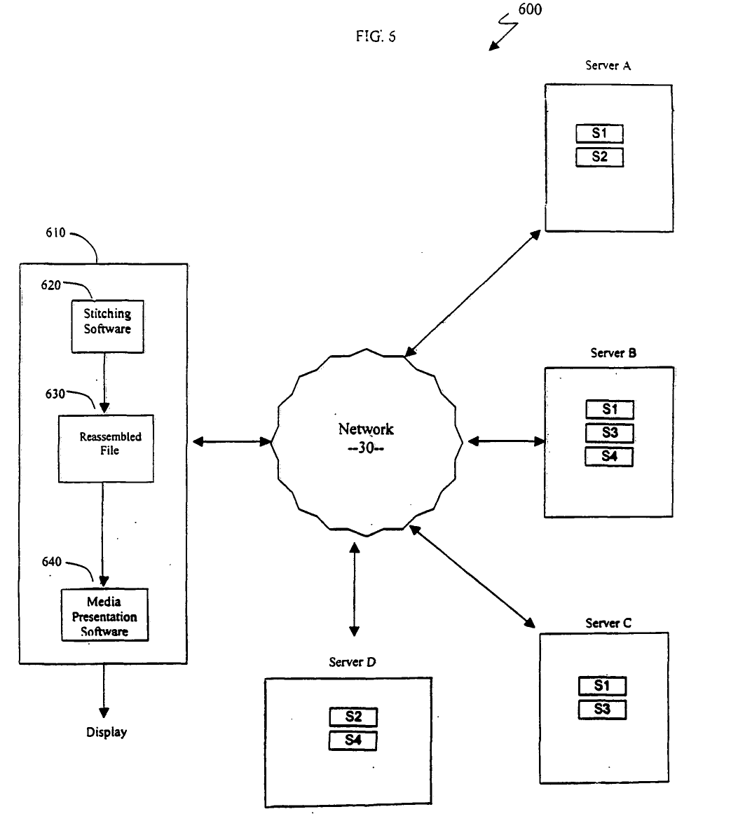

FIG. 5 is a flow chart illustrating one embodiment of a process flow for configuring a file for storage. Proceeding from a START state, the process 500 proceeds to configure an original file, such as file 300 of FIG. 3, for transmission. The process 500 begins by determining the number and size of segments that the original file 300 should be divided into, as shown in process block 520. The process 500 then determines the size and number of sub-files that the segments should be assembled into (process block 530). Next, the process 500 determines the order of assembling the segments into each sub-file (process block 540).

The process 500 is then ready to divide the original file, and proceeds to configure the original file by dividing it into segments, and thereafter assembling the segments into the sub-files, as discussed above (process block 550). The process 500 then determines how the sub-files should be distributed to various servers for storage (process block 560). When this has been determined, the process 500 distributes and stores the sub-files onto the servers (process block 570). The process 500 then terminates or returns to the main process.

FIG. 6 is a block diagram illustrating one example of a networked system 600 that implements one embodiment of the invention. Client system 610 running client-side software, is connected to one or more servers over network 30. Moreover, in this embodiment Servers A, B, C and D are running server-side software, and are connected to network 30. However, it should be appreciated that client system 610 and Servers A-D may be connected using any known communication link.

In one embodiment, the client-side software of client system 610 includes stitching software 620, which may be used to create reassembled file 630. Thereafter, reassembled file 630 may be provided to media presentation software 640 for display. In one embodiment, stitching software 620 is used to reassemble file segments which have been downloaded from one or more of the Servers A-D. While any known means of reassembling file segments may be used, the method described in the PCT/US ______ patent application may be used, according to one embodiment.

Continuing to refer to FIG. 6, sub-files S1 and S2 from FIG. 4 have been loaded onto Server A. Similarly, sub-files S1, S3 and S4 have been loaded onto Server B, sub-files S1 and S3 have been loaded onto Server C and sub-files S2 and S4 have been loaded onto Server D. Thus, in this embodiment the original file 300 (see FIG. 3) has been split into four sub-files S1 310, S2 320, S3 330 and S4 340, with each of the four sub-files S1-S4 being available from more than one server. As described earlier, this arrangement improves the speed at which a user will be able to download a given file.

The sub-files S1, S2, S3 and S4 may be accessed via network 30 upon demand. Upon retrieval, the files may be recombined using stitching software 520 into reassembled file 530. Thereafter, reassembled file 530 may be provided to media presentation software 540 for display.

While the preceding description has been directed to particular embodiments, it is understood that those skilled in the art may conceive modifications and/or variations to the specific embodiments described herein. Any such modifications or variations which fall within the purview of this description are intended to be included therein as well. It is understood that the description herein is intended to be illustrative only and is not intended to limit the scope of the invention.

What is claimed is:

1. A method for providing content over a network comprising:
splitting said content into a plurality of segments;
organizing a first plurality of said segments into a first sub-file;
organizing a second plurality of said segments into a second sub-file;
storing said first sub-file and second sub-file on one or more servers;
providing sub-file data to a user computer, said sub-file data to identify a server location of said first sub-file and second sub-file;
streaming said first sub-file and second sub-file, in response to a request, to the user computer over the network.

2. The method of claim 1, further comprising organizing a remainder of said plurality of segments into additional sub-files, such that all of said plurality of segments are distributed between said first sub-file, said second sub-file, and said additional sub-files.

3. The method of claim 1, further comprising organizing said plurality of segments into a plurality of sub-files according to an order.

4. The method of claim 3, wherein organizing said plurality of segments comprises organizing said plurality of segments into the plurality of sub-files according to the order, said order to be characterized by organizing a first segment into the first sub-file, a second segment into one of the first or the second sub-file, and a third segment into one of the first or the second sub-file.

5. The method of claim 3, wherein said plurality of sub-files are further organized into a plurality of sub-file groups, and wherein organizing said plurality of segments comprises organizing said plurality of segments into the plurality of sub-files according to the order, said order to be characterized by organizing a first sequence of segments across a first sub-file group, followed by organizing a second sequence across the first sub-file group.

6. The method of claim 1, wherein storing said first sub-file and second sub-file on one or more servers comprises storing each of said first sub-file and second sub-file on a first server connected to said network.

7. The method of claim 1, wherein storing said first sub-file and second sub-file on one or more servers comprises storing said first sub-file on a first server and said second sub-file on a second server, said first server and second server to be connected to the network.

8. The method of claim 1, wherein storing said first sub-file and second sub-file on one or more servers comprises storing each of said first sub-file and second sub-file on a first server, and storing at least one of said first sub-file and second sub-file on a second server, said first server and second server to be connected to the network.

9. The method of claim 8, farther comprising organizing a remainder of said plurality of segments into additional sub-files, and storing at least one of said additional sub-files on a third server.

10. The method of claim 1, wherein providing sub-file data to the user computer comprises providing sub-file data to the user computer where said sub-file data is to include a location of said first sub-file and second sub-file, said sub-file data to further identify which of said plurality of segments is organized into the first sub-file and which of said plurality of segments is organized into the second sub-file.

11. The method of claim 1, further comprising, after said streaming, combining said first sub-file and second sub-file by the user computer using the sub-file data.

12. A network server comprising:
a processor;
a communications port, coupled to the processor, said communications port to be used to connect the network server to a network; and,
a memory, coupled to the processor, said memory to include instruction sequences for causing said processor to,
split media content into a plurality of segments,
organize a first plurality of said segments into a first sub-file,
organize a second plurality of said segments into a second sub-file,
store said first sub-file and second sub-file on one or more servers,
provide sub-file data to a user computer, said sub-file data to identify a location of said first sub-file and second sub-file, and
stream said first sub-file and second sub-file, in response to a request, to the user computer over the network.

13. The network server of claim 12, wherein said memory further includes instruction sequences to cause said processor to organize a remainder of said plurality of segments into additional sub-files, such that all of said plurality of segments are distributed between said first sub-file, said second sub-file, and said additional sub-files.

14. The network server of claim 12, wherein said memory further includes instruction sequences for causing said processor to organize said plurality of segments into a plurality of sub-files according to an order.

15. The network server of claim 14, wherein said order is characterized by organizing a first segment into the first sub-file, a second segment into one of the first or the second sub-file, and a third segment into one of the first or the second sub-file.

16. The network server of claim 14, wherein said memory further includes instruction sequences for causing said processor to organize said plurality of sub-files into a plurality of sub-file groups, and wherein organizing said plurality of segments comprises organizing said plurality of segments into a plurality of sub-files according to the order, said order to be characterized by organizing a first sequence of segments across a first sub-file group, followed by organizing a second sequence across the first sub-file group.

17. The network server of claim 12, wherein each of said first sub-file and second sub-file are stored on a first server connected to said network.

18. The network server of claim 12, wherein said first sub-file is stored on a first server and said second sub-file is stored on a second server, said first server and second server to be connected to the network.

19. The network server of claim 12, wherein each of said first sub-file and second sub-file are stored on a first server, and at least one of said first sub-file and second sub-file is stored on a second server, said first server and second server to be connected to the network.

20. The network server of claim 19, wherein said memory further includes instruction sequences to cause said processor to organize a remainder of said plurality of segments into additional sub-files, and to store at least one of said additional sub-files on a third server.

21. The network server of claim 12, wherein said sub-file data is to further identify which of said plurality of segments is organized into the first sub-file and which of said plurality of segments is organized into the second sub-file.

22. A computer program product, comprising:
a computer usable medium having computer readable program code embodied therein to provide content over a network, the computer readable program code in said computer program product comprising:
first computer readable program code to split said content into a plurality of segments;
second computer readable program code to organize a first plurality of said segments into a first sub-file;
third computer readable program code to organize a second plurality of said segments into a second sub-file;
fourth computer readable program code to store said first sub-file and second sub-file on one or more servers;
fifth computer readable program code to provide sub-file data to a user computer, said sub-file data to identify a server location of said first sub-file and second sub-file;
sixth computer readable program code to stream said first sub-file and second sub-file, in response to a request, to the user computer over the network.

23. The computer program product of claim 22, further comprising seventh computer readable program code to organize a remainder of said plurality of segments into additional sub-files, such that all of said plurality of segments are distributed between said first sub-file, said second sub-file, and said additional sub-files.

24. The computer program product of claim 22, wherein said first computer readable program code comprises first computer readable program code to split said content into a plurality of segments and to organize said plurality of segments into a plurality of sub-files according to an order.

25. The computer program product of claim 24, wherein said order is characterized by organizing a first segment into the first sub-file, a second segment into one of the first or the second sub-file, and a third segment into one of the first or second sub-file.

26. The computer program product of claim 24, further comprising seventh computer readable program code to organize said plurality of sub-files into a plurality of sub-file groups, and wherein said first computer readable program code comprises first computer readable program code to organize said plurality of segments into a plurality of sub-files according to the order, said order to be characterized by organizing a first sequence of segments across a first sub-file group, followed by organizing a second sequence across the first sub-file group.

27. The computer program product of claim 22, wherein the fourth computer readable program code comprises fourth computer readable program code to store each of said first sub-file and second sub-file on a first server connected to said network.

28. The computer program product of claim 22, wherein the fourth computer readable program code comprises fourth computer readable program code to store said first sub-file on a first server and said second sub-file on a second server, said first server and second server to be connected to the network.

29. The computer program product of claim 22, wherein the fourth computer readable program code comprises fourth computer readable program code to store each of said first sub-file and second sub-file on a first server, and to store at least one of said first sub-file and second sub-file on a second server, said first server and second server to be connected to the network.

30. The computer program product of claim 29, further comprising seventh computer readable program code to organize a remainder of said plurality of segments into additional sub-files, and to store at least one of said additional sub-files on a third server.

31. The computer program product of claim 22, wherein the fifth computer readable program code comprises fifth computer readable program code to provide sub-file data to the user computer, where said sub-file data is to include a location of said first sub-file and second sub-file, said sub-file data to further identify which of said plurality of segments is organized into the first sub-file and which of said plurality of segments is organized into the second sub-file.
